(19) United States
(12) Patent Application Publication
(10) Pub. No.: US 2007/0085316 A1
(43) Pub. Date: Apr. 19, 2007

(54) Airbag folding method and folded airbag produced thereby

(75) Inventors: John P. Ruterbusch, Rochester Hills, MI (US); Jaime F. Perez, Lake Orion, MI (US); Rodolfo Gonzalez, Tlaquepaque Jalisco (MX)

Correspondence Address: FOLEY AND LARDNER LLP;SUITE 500, 3000 K STREET NW, WASHINGTON, DC, 20007, US

(73) Assignee: TK HOLDINGS, INC.

(21) Appl. No.: 11/580,232

(22) Filed: Oct. 13, 2006

Related U.S. Application Data
(60) Provisional application No. 60/726,237, filed on Oct. 14, 2005.

(51) Int. Cl. B60R 21/237

(52) U.S. Cl. 280/743.1; 493/405

(57) ABSTRACT

An airbag includes a first chamber and a second chamber. The second chamber includes a first portion, a first lobe extending from the first portion, and a second lobe extending from the first portion. The airbag is arranged such that upon inflation of the airbag, the first chamber inflates before the second chamber and the first portion inflates before the first lobe and second lobe.

### CROSS-REFERENCE TO RELATED APPLICATIONS

The present application claims the benefit under 35 U.S.C. § 119(e) of U.S. Provisional Patent Application No. 60/726,237, filed Oct. 14, 2005, the entire disclosure of which is incorporated herein by reference.

### BACKGROUND

The present invention relates generally to the field of airbags and methods of folding such airbags. More specifically, the present invention relates to airbags that are folded in such a way as to control the manner in which the airbags deploy.

Airbags used to protect passengers during an automobile collision may be mounted at various locations within the passenger compartment, including within steering wheels, dashboards, vehicle pillars, seats, and other suitable locations. Certain of these vehicle-mounted airbags are intended to provide cushioning for vehicle passengers moving forward within the passenger compartment during a collision.

One difficulty with airbags conventionally provided within a vehicle relates to the fact that child restraint seats may be provided in a rear-facing position within a vehicle. While in such a case the airbag may provide cushioning between the child seat and the front of the vehicle, the inflation of the airbag may also result in the airbag deploying against a rear surface of the child seat, which may cause the child seat to be forced toward the rear of the vehicle with further inflation of the airbag.

It would be desirable to provide a method of folding an airbag that controls the manner in which the airbag inflates upon deployment. It would also be desirable to provide an airbag that is folded in such a manner that the airbag may provide cushioning either to a vehicle occupant sitting in a vehicle seat or to a vehicle occupant sitting in a rear facing child restraint seat. It would be desirable to provide a method of folding an airbag and an airbag that provide any one or more of these or other advantageous features as will be apparent to those reviewing this disclosure.

### SUMMARY

An exemplary embodiment of the invention relates to an airbag that includes a first chamber and a second chamber. The second chamber includes a first portion, a first lobe extending form the first portion, and a second lobe extending from the first portion. The airbag is arranged such that upon inflation of the airbag, the first chamber inflates before the second chamber and the first portion inflates before the first lobe and second lobe.

Another exemplary embodiment of the invention relates to an airbag assembly that includes an airbag including a first portion and a second portion. The second portion includes a first lobe and a second lobe. The airbag assembly also includes a member for securing the airbag in a folded arrangement. The first portion has an accordion-style fold and the second portion is provided as a roll with the first lobe and the second lobe provided in the interior of the roll. The airbag assembly is configured such that the first portion will inflate before the second portion.

Another exemplary embodiment of the invention relates to a method for preparing an airbag assembly that includes folding a first portion of an airbag accordion-style and rolling a second portion of the airbag to form a roll. The second portion includes a first lobe and a second lobe, and the first lobe and the second lobe are provided in the interior of the roll. The method further includes providing a member to secure the first portion in its folded arrangement and the second portion in its rolled arrangement, with the first portion provided adjacent the second portion.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIGS. 1-42 are drawings illustrating a method of folding an airbag according to an exemplary embodiment of the present invention.

FIG. 43 shows a series of drawings illustrating the inflation of an airbag similar to that shown in FIG. 1 that has been folded using a method such as that described according to an exemplary embodiment illustrated in FIGS. 1-42.

### DETAILED DESCRIPTION

According to an exemplary embodiment, an improved method of folding an airbag is provided that results in a folded airbag that will deploy in a controlled manner to reduce undesirable interactions between the airbag and a rear surface of a rear-facing child restraint seat. According to a particular exemplary embodiment, the airbag is folded such that a portion of the airbag will deploy above a top of the rear-facing child restraint seat.

FIG. 1 illustrates an airbag 100 in an unfolded condition. According to an exemplary embodiment, the airbag 100 is a split-cushion (e.g., dual lobe or NCPM) top-mount airbag or the like. The airbag 100 may be folded in such a manner that the airbag 100 will be forced to “walk” up and over a seat back of a rear facing child safety seat during deployment. The airbag 100 could also be mounted in a door, in a steering wheel, in a headliner of the vehicle, along the side roofline, or any other suitable location for protecting a vehicle occupant. According to an exemplary embodiment, the airbag 100 is inflated by a gas generator (not shown).

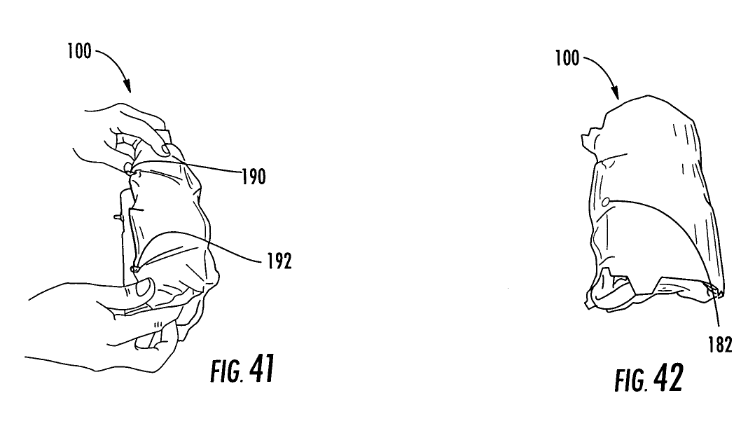

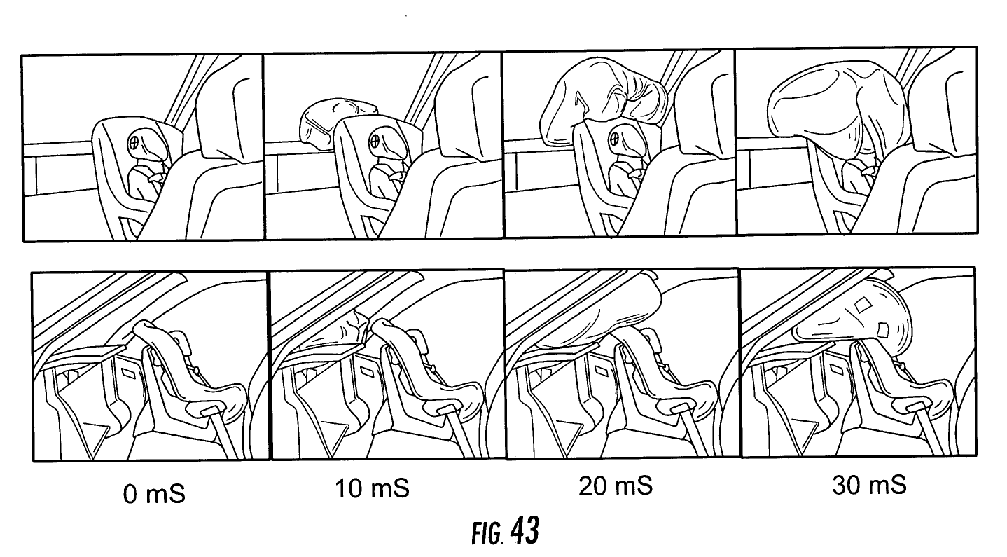

The airbag 100 comprises panels which are sewn together at a seam 110 to form the inflatable cushion. The airbag 100 includes a first chamber 120 (e.g., a top chamber), a second chamber 130 (e.g., a bottom chamber), a first side or portion 140, and a second side or portion 150. The first side 140 includes a first lobe 142 and the second side 150 includes a second lobe 152. The airbag 100 may also include a diffuser 195 (FIG. 40), which is located at the underside of the airbag 100 as it is oriented in FIG. 1. Each lobe 142, 152 is an extension of its respective side 140, 150, which extends away from the main portion of the airbag 100 (i.e., the second or bottom chamber 130 includes a first “main” portion and two lobes extending from the first portion). It should be noted that while various portions of the airbag 100 are referred to as the “top chamber,” “bottom chamber,” “first side,” and “second side,” the interior of the airbag consists of a single space. That is, the airbag does not include separate sections that are filled separately from different sources when the airbag is inflated (e.g., the first side and second side are in fluid communication with each other within the airbag).

To fold the airbag 100, the airbag 100 is first positioned on one side on a folding table 160 such that the airbag 100 lays flat, as shown in FIG. 1. The airbag 100 is provided on the folding table 160 such that each lobe 142, 152 is symmetric about a centerline 102 of the airbag 100.

Next, in a step as shown in FIG. 2, the first side 140 and first lobe 142 are folded over the second side 150 and the second lobe 152 such that the first side 140 and first lobe 142 are provided on top of the second side 150 and second lobe 152.

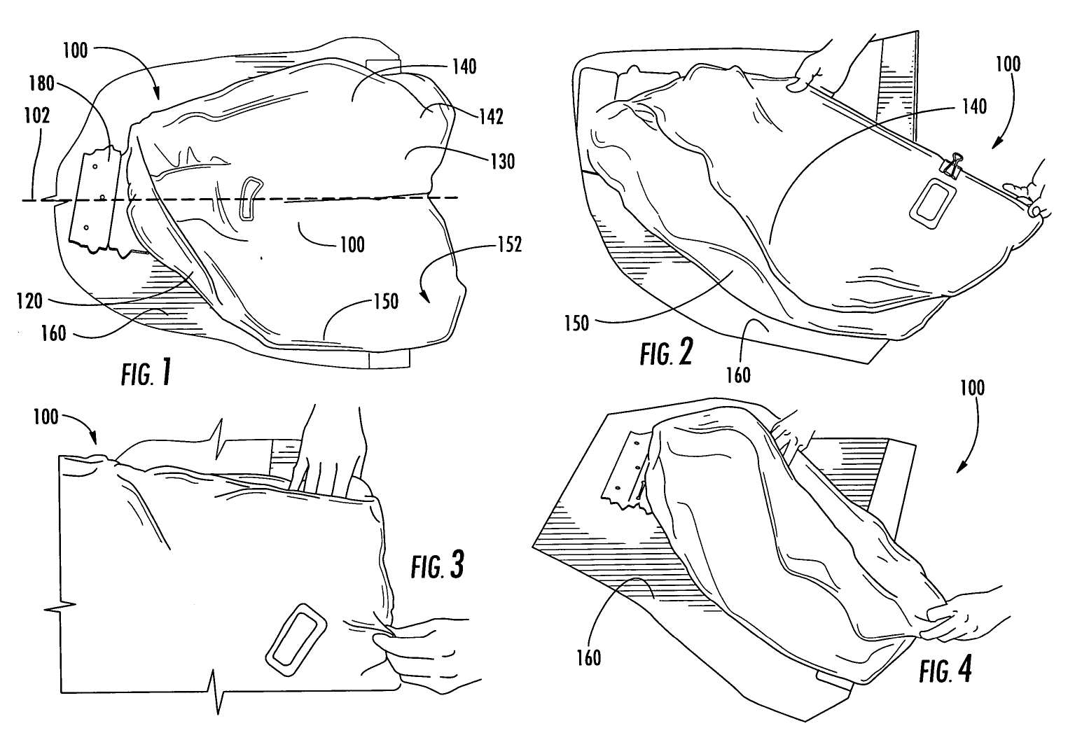

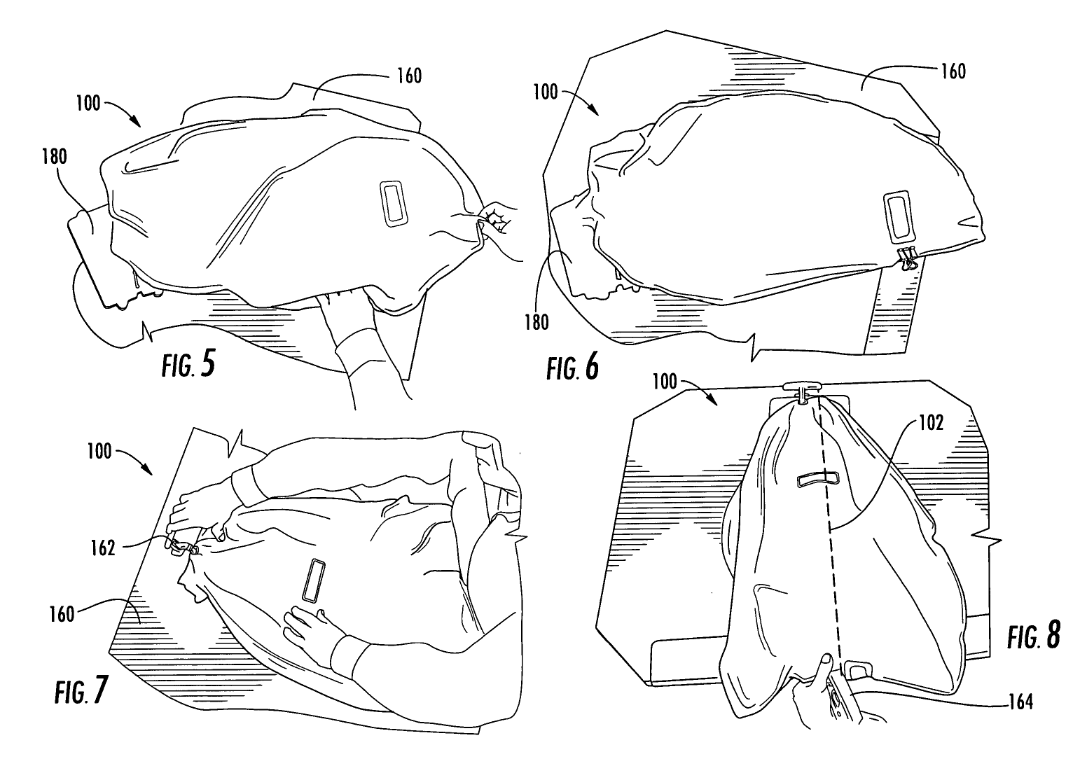

As shown in FIGS. 3-5, a portion of the first lobe 142 is then tucked into the space defined by the airbag 100 at the first side 140 of the airbag 100. Thus, the portion of the first lobe 142 is essentially inverted (i.e., turned inside-out) such that it extends into the cushion. Optionally, a clip (shown as clip 160 in FIG. 6) may be used to secure the first lobe 142 in its “tucked away” position. Although not shown in the FIGURES, the same step is repeated for the second lobe 152. As a result of this step, portions of both of the lobes 142 and 152 are tucked into the cushion such that they no longer extend outward and away from the body of the airbag 100.

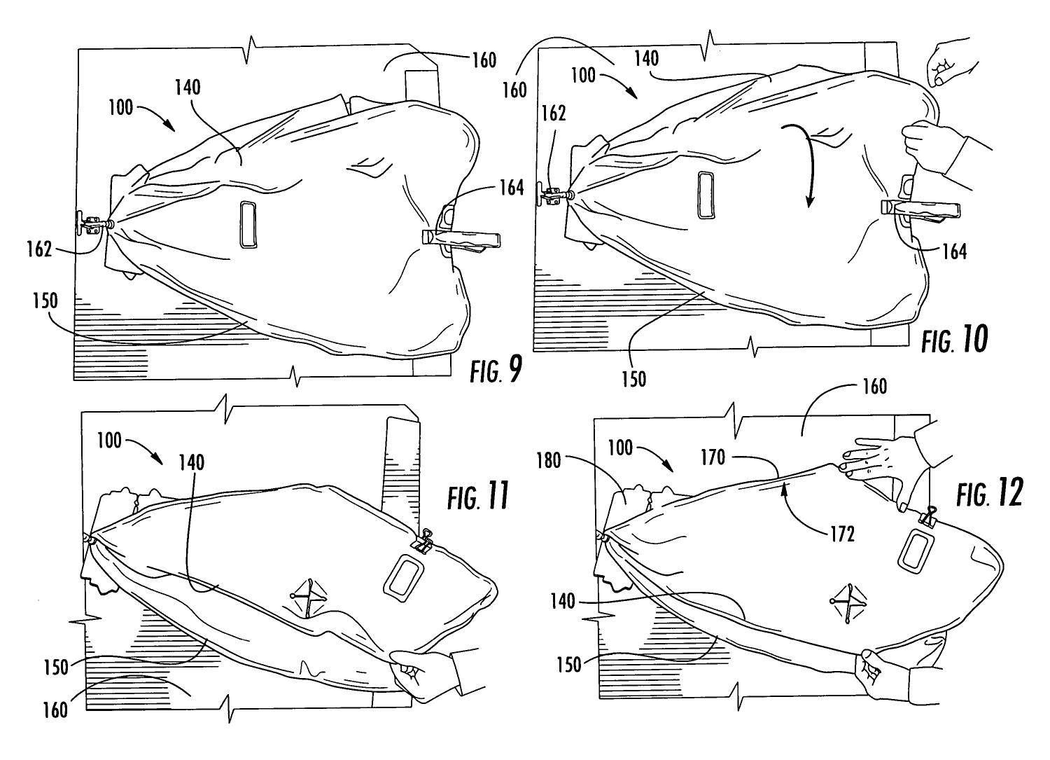

As shown in FIGS. 7-9, the first side 140 is then folded away from the second side 150 of the airbag 100 such that the airbag again lays flat on the table 160. The top and bottom of the airbag 100 are then secured to the table 160 using clips 162 and 164 or similar devices that are placed along the centerline (shown as dashed line 102 in FIG. 1). It should be noted that other mechanisms may be used to secure the top and the bottom of the airbag 100 to the table 160. According to other exemplary embodiments, no mechanism is provided to secure the top and bottom of the airbag to the table 160.

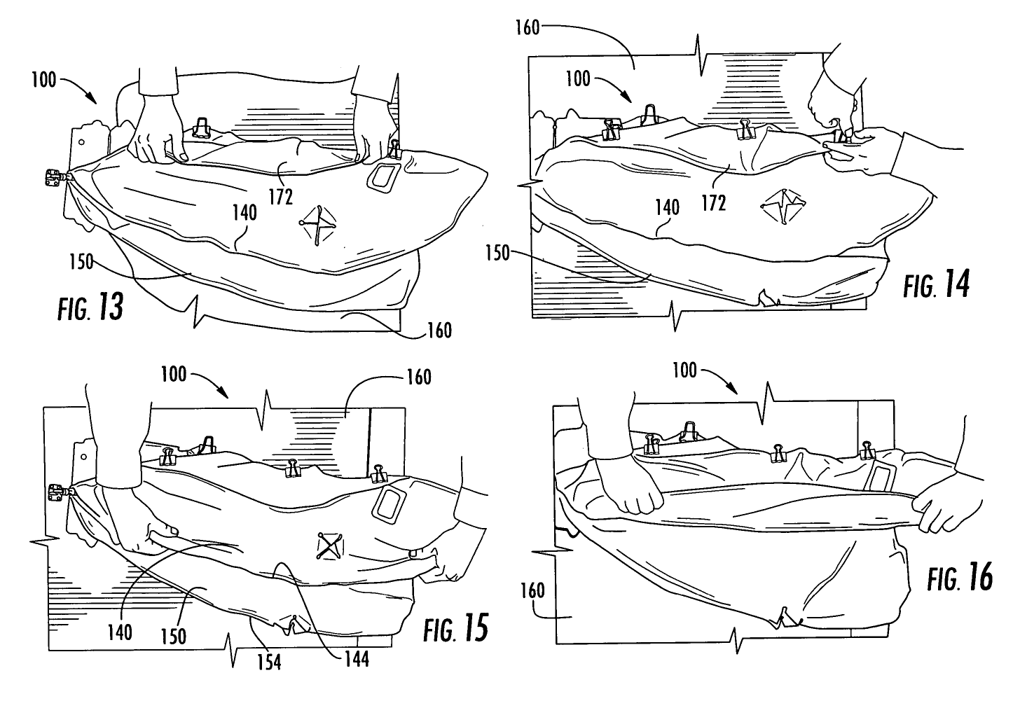

Next, as shown in FIGS. 10-12, the first side 140 is again folded such that it is positioned on top of the second side 150. The rear surface of the airbag is also formed of panels that are secured together at a seam 170 (FIG. 12). When the airbag 100 is folded about the seam 170 such that the first side 140 is positioned over the second side 150, the seam defines an extension 172 that extends away from the rest of the airbag 100. In a step illustrated in FIG. 13, the extension 172 is rolled over on itself toward the rest of the airbag and optionally secured with a clip as shown in FIG. 14.

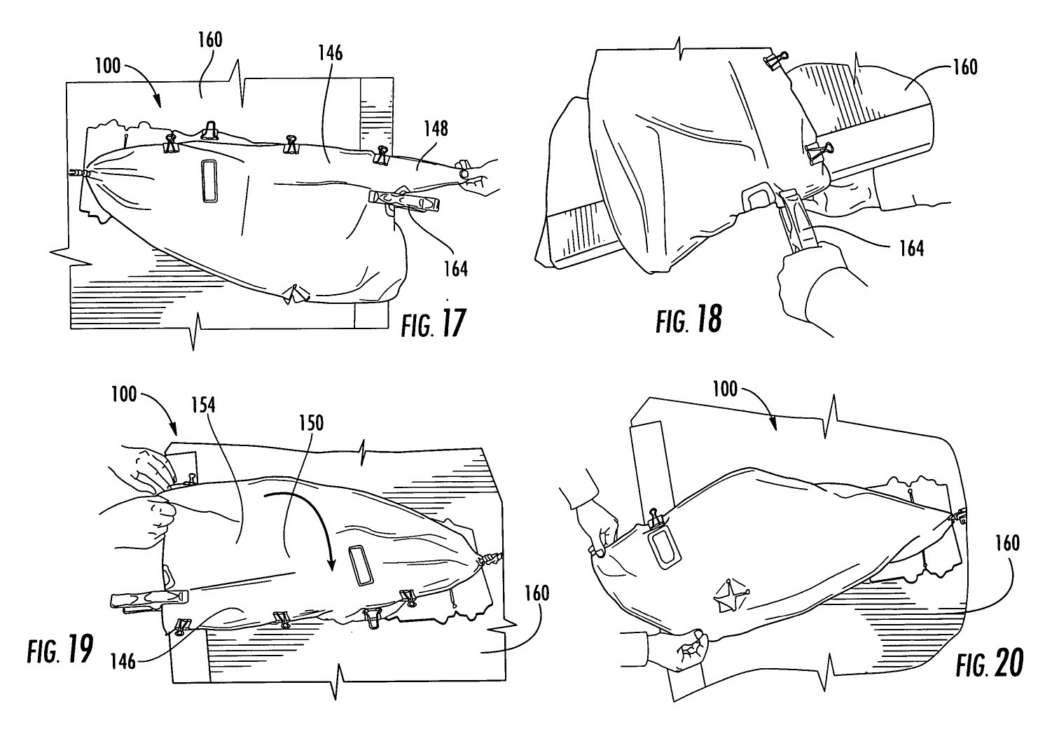

Subsequent to rolling the extension 172 inward, an end 144 of the first side 140 is folded once back onto itself as shown in FIG. 15, after which it is rolled a number of times as shown in FIG. 16 to form a first relatively compact folded portion. This first compact portion 146 is then optionally secured with one or more clips or other fasteners as shown in FIG. 17. An extension or “leg” 148 extends from a first end of the first compact portion 146.

After the first compact portion 146 having the leg 148 are formed in the folding operation, the clip 164 is moved from its original position (FIG. 17) to a new position that secures the first compact portion 146 in place, as shown in FIG. 18. The leg 148 is folded under the table 160 such that the clip 164 clamps the leg 148, the first compact portion 146, and a portion of the table 160.

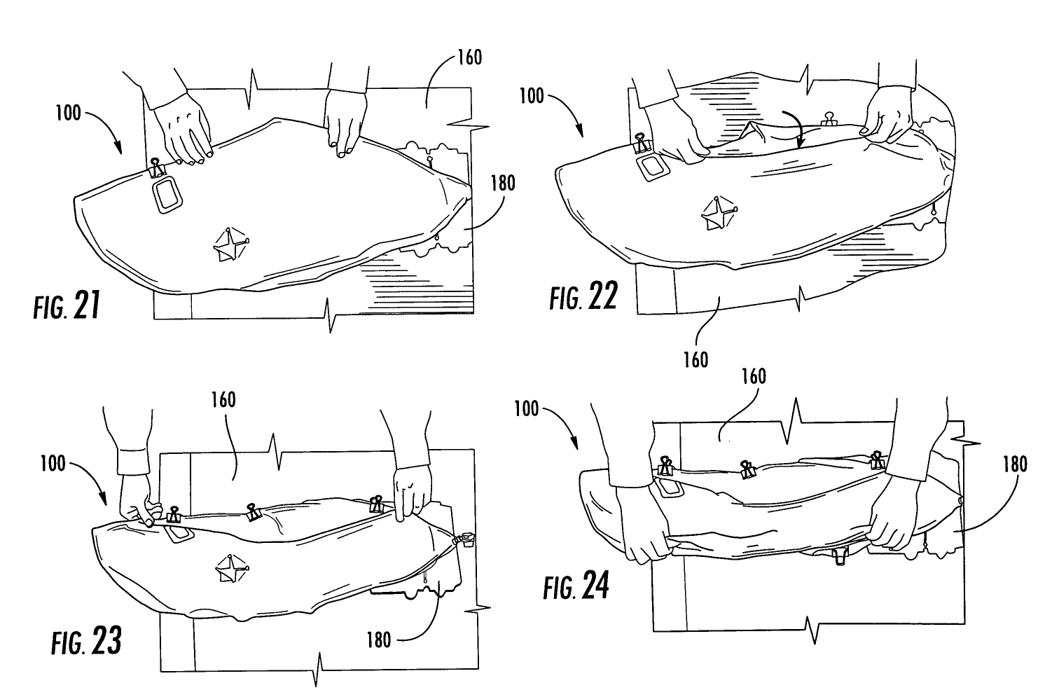

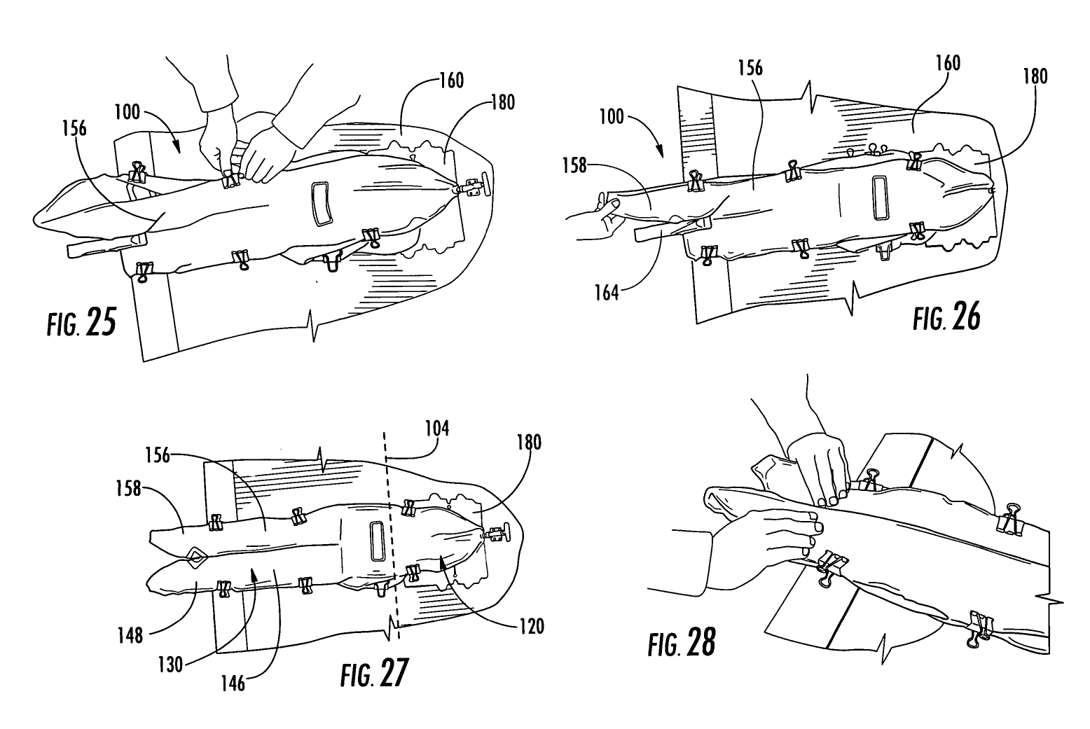

FIGS. 19-26 illustrate further folding of the airbag 100 in which the steps shown in FIGS. 10-16 are repeated for the second side 150 of the airbag 100, resulting in the formation of a second relatively compact folded portion 156 having an extension or leg 158 as shown in FIGS. 25-26. The clip 164 is then removed in FIG. 27 and the first compact portion 146 and the second compact portion 156 are provided next to each other such that the airbag is flat on the table 160.

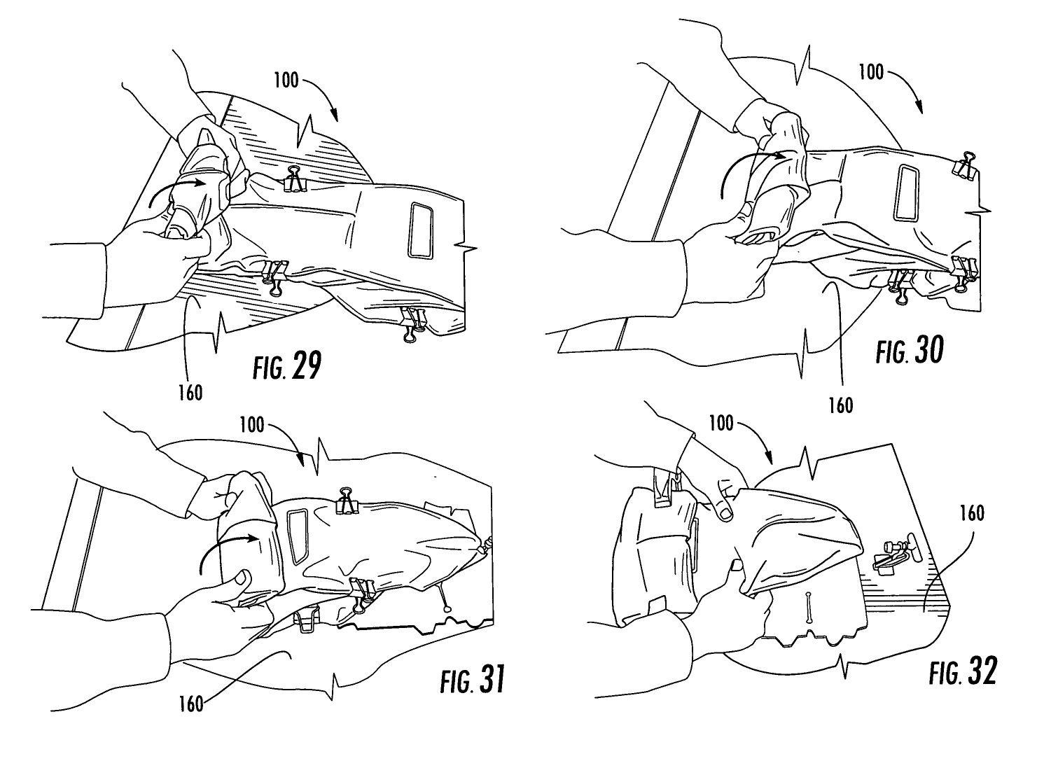

The bottom chamber 130 of the airbag 100 is then folded separately from the top chamber 120 in subsequent folding steps. A dashed line 104 is provided in FIG. 27 to illustrate the division between the top chamber 120 and the bottom chamber 130. In FIG. 28, the legs 148, 158 are rolled onto themselves toward the top chamber 120, after which the bottom chamber is rolled three times (one roll each is shown in each of FIGS. 29-31). According to other exemplary embodiments, a different number of rolls may be utilized such that the material of the bottom chamber 130 is rolled to the line 104. As shown in FIG. 32, the bottom chamber 130 in its rolled configuration may then optionally be clamped with a clip or other fastener to secure it in place during folding of the top chamber 120. Upon deployment of the airbag, the roll will begin to unravel, with the legs 148, 158 (and consequently, the lobes 142, 152) unraveling and expanding last.

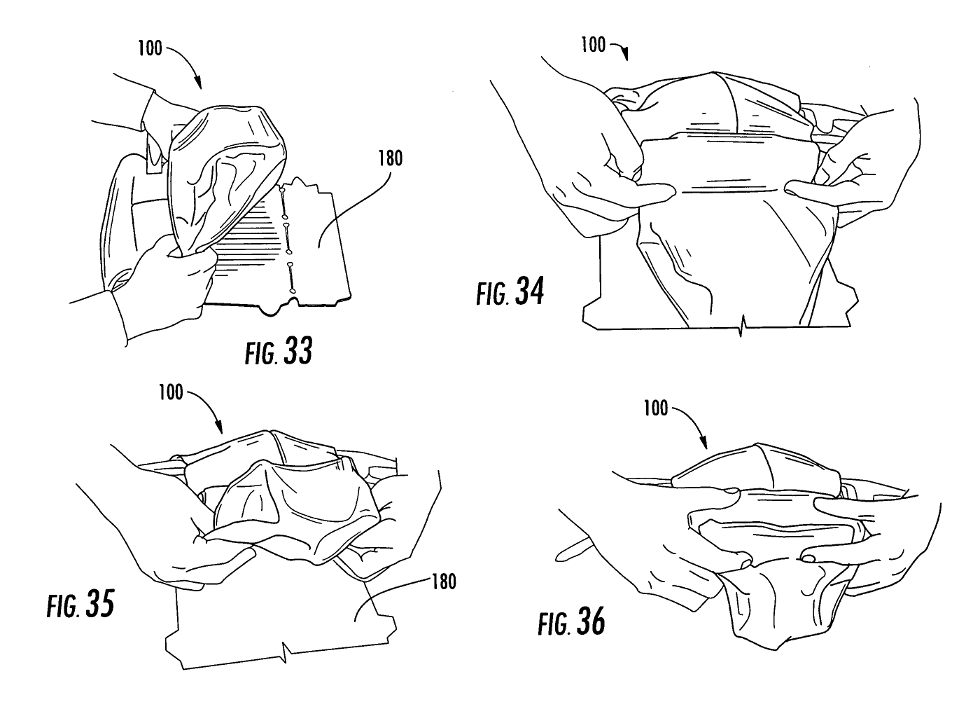

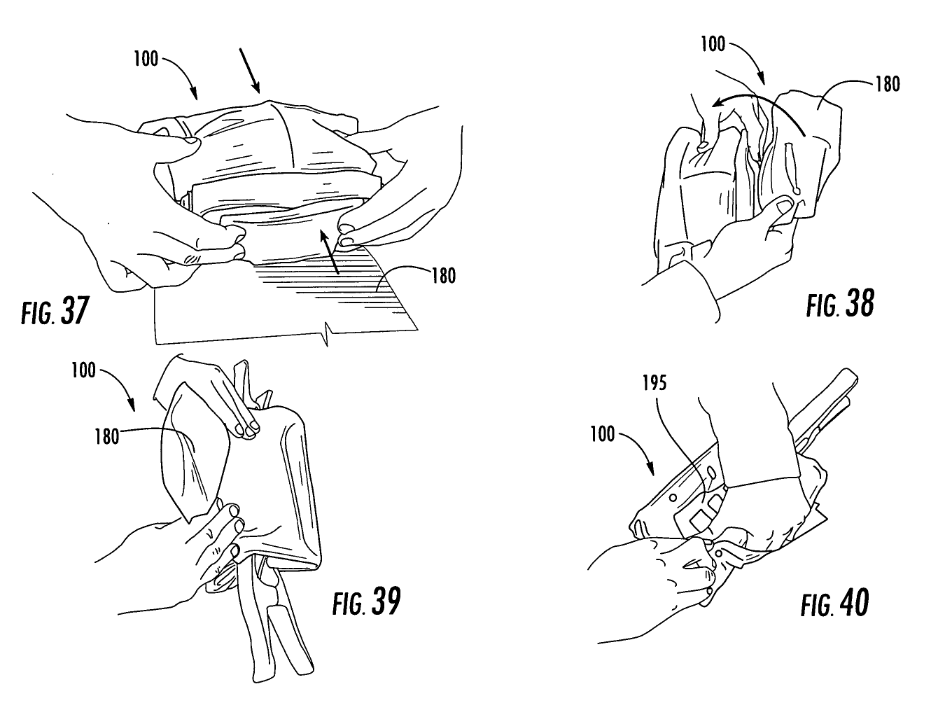

As shown in FIGS. 33-37, the top chamber 120 is then folded, accordion-style, until it is relatively compact, and is provided adjacent the rolled bottom chamber 120. In FIGS. 38-40, a member or element in the form of a bag wrap 180 (e.g., a piece or flap of material) is folded around the folded airbag 100. The bag wrap 180 is coupled to the airbag 100 and has apertures or holes for receiving bolts 190, 192 provided on the diffuser of the airbag 100, which acts to secure the airbag in its folded configuration until deployment. As shown in FIG. 41, a portion or region of the bag wrap 180 includes features intended to allow the bag wrap to break in a controlled manner upon deployment of the airbag (illustrated as perforations 182). According to an exemplary embodiment, when the airbag 100 is deployed, the bag wrap 180 will sever along the perforations 182 to allow the airbag to expand.

FIG. 43 illustrates deployment of an airbag similar to that shown as airbag 100 described above, and folded in the same manner. Because of the manner in which the airbag is folded, gas used to inflate the airbag acts to inflate the airbag in a controlled manner that allows the lobes (e.g., lobes 142 and 152) to inflate only after they have been forced over the top of a rear-facing child seat. The top row of photos in FIG. 43 are front views of the child seat, while the bottom row of photos show side views at the same time. As illustrated in FIG. 43, the airbag inflates partially between 10 and 20 milliseconds to unfold and inflate the top chamber of the airbag. After that portion of the airbag is inflated, the bottom chamber is inflated by unrolling the bottom chamber so that it “walks” up the rear of the child seat and extends over the child seat before “untucking” and inflating the lobes. Between 30 and 40 milliseconds, the lobes inflate about the head of the occupant of the child seat.

One advantageous feature of the method of folding an airbag as described above is that inflation of the lobes 142, 152 may be controlled so that it occurs at the appropriate time and position relative to the occupant. As opposed to other methods of folding the airbag (e.g., a “crush” folding method), which may result in the airbag inflating entirely behind the rear surface of the child seat (thus forcing the child seat forward toward the vehicle seat), the folding method described herein allows for controlled inflation of the airbag in a manner that is optimized to provide appropriate cushioning for the vehicle occupant.

One advantage of utilizing the folding method described herein is that rear facing infant seat (RFIS) testing is required as part of government crash test standards. The folding method described herein is intended to allow compliance with the government standards without requiring a complete redesign of the NCPM airbag. Additionally, by providing a folded airbag such as that shown and described herein, it is intended that relatively costly seat sensors may be eliminated (e.g., sensors which determine whether an adult or a child seat is occupying a seat adjacent the airbag), since deployment of the airbag will be satisfactory regardless of the weight, size, or positioning of the occupant.

It is important to note that the construction and arrangement of the airbag as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the preferred and other exemplary embodiments without departing from the scope of the present inventions as expressed in the appended claims.

What is claimed is:

1. An airbag comprising:
a first chamber; and
a second chamber comprising a first portion, a first lobe extending form the first portion, and a second lobe extending from the first portion;
wherein the airbag is arranged such that upon inflation of the airbag, the first chamber inflates before the second chamber and the first portion inflates before the first lobe and second lobe.

2. The airbag of claim 1, wherein the airbag is arranged such that the first chamber of the airbag is folded accordion-style.

3. The airbag of claim 2, wherein the airbag is arranged such that the second chamber is provided as a roll.

4. The airbag of claim 3, wherein the first lobe and the second lobe are provided in the interior of the roll.

5. The airbag of claim 4, wherein the roll is configured such that upon deployment of the airbag, the first lobe and the second lobe will be the last portion of the roll to unravel.

6. The airbag of claim 1, further comprising a member coupled to the airbag for maintaining the airbag in a folded configuration.

7. The airbag of claim 6, wherein the member comprises a flap of material comprising features intended to allow the flap of material to break upon deployment of the airbag to allow the airbag to expand.

8. The airbag of claim 7, wherein the features are perforations.

9. The airbag of claim 6, wherein the member includes a plurality of apertures for securing the member to a diffuser for the airbag.

10. The airbag of claim 1, wherein the airbag is a split-cushion airbag.

11. An airbag assembly comprising:
an airbag including a first portion and a second portion, the second portion including a first lobe and a second lobe; and
a member for securing the airbag in a folded arrangement;
wherein the first portion has an accordion-style fold; and
wherein the second portion is provided as a roll with the first lobe and the second lobe provided in the interior of the roll; and
wherein the airbag assembly is configured such that the first portion will inflate before the second portion.

12. The airbag assembly of claim 11, wherein the member comprises a flap of material comprising features intended to allow the flap of material to break upon deployment of the airbag to allow the airbag to expand.

13. The airbag assembly of claim 12, wherein the features are perforations.

14. The airbag assembly of claim 11, wherein the member includes a plurality of apertures for securing the member to a diffuser for the airbag.

15. The airbag assembly of claim 11, wherein the second portion comprises a main portion and the first lobe and the second lobe extend from the main portion.

16. The airbag assembly of claim 15, wherein the airbag is configured such that the main portion unrolls before the first lobe and the second lobe upon deployment of the airbag.

17. The airbag assembly of claim 11, wherein the airbag is a split-cushion airbag.

18. A method for preparing an airbag assembly comprising:
folding a first portion of an airbag accordion-style;
rolling a second portion of the airbag to form a roll, the second portion including a first lobe and a second lobe, the first lobe and the second lobe provided in the interior of the roll; and
providing a member to secure the first portion in its folded arrangement and the second portion in its rolled arrangement, the first portion provided adjacent the second portion.

19. The method of claim 18, wherein providing the member comprises wrapping the member around at least a portion of the first portion and the second portion.

20. The method of claim 18, wherein the step of rolling the second portion comprises rolling the first lobe and second lobe toward the first portion.

21. The method of claim 18, wherein the step of rolling the second portion is performed before the step of folding the first portion.

22. The method of claim 18, wherein the airbag includes a first side and a second side, and further comprising tucking a portion of the first side and a portion of the second side into the airbag before the step of rolling the second portion.

23. The method of claim 18, wherein the airbag is a split-cushion airbag.

24. The method of claim 18, wherein the airbag is secured in place by the member such that upon deployment of the airbag, a portion of the member will tear to allow the first portion to expand prior to the expansion of the second portion.
